(19) United States
(12) Patent Application Publication
(10) Pub. No.: US 2021/0309274 A1
(43) Pub. Date: Oct. 7, 2021

(54) APPLIANCE DOLLY

(71) Applicant: Justin Barker, Mesa, AZ (US)

(72) Inventor: Justin Barker, Mesa, AZ (US)

(21) Appl. No.: 16/842,559

(22) Filed: Apr. 7, 2020

(51) Int. Cl. B62B 3/10; B62B 5/04; B62B 5/06

(52) U.S. Cl. CPC B62B 3/104; B62B 5/06; B62B 5/0433

(57) ABSTRACT

The present disclosure is directed to a hot water heater dolly that allows a user to move and place a hot water heater onto a platform or stand for installation. In embodiments, a hot water heater could be leaned onto a dolly, wheeled into place, and then stood upright from the dolly onto a platform. This solves the problem of deadlifting a water heater onto a platform or stand during installation.

### BACKGROUND OF THE DISCLOSURE

### Field of the Invention

The disclosure is generally directed to appliance dolly's, appliance trucks, or appliance hand trucks. More specifically, in embodiments, the disclosure is directed to trucks or dollies convenient for moving water heaters.

### Description of the Related Art

Moving a hot water onto a stand or platform for use generally means dead-lifting the water heater onto the stand or platform. Water heaters are large and unwieldy and it is difficult to move a water heater and place it correctly on a platform or stand. Accordingly, there is a need for a water heater dolly or truck that can move and conveniently and reliably place a water heater on a stand or platform for use.

### SUMMARY OF THE INVENTION

The present disclosure is directed to a hot water heater dolly that allows a user to move and place a hot water heater onto a platform or stand for use. In embodiments, a hot water heater could be leaned onto a dolly, wheeled into place, and then stood upright from the dolly onto a platform. This solves the problem of deadlifting a water heater onto a platform or stand during installation.

Other features and aspects will be apparent from the following detailed description, the drawings, and the claims

### BRIEF DESCRIPTION OF THE DRAWINGS

FIG. 1 shows one embodiment of a water heater dolly of the present disclosure.

FIG. 2 shows another embodiment of a water heater dolly of the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The present disclosure is directed to a hot water heater dolly that allows a user to move and place a hot water heater onto a platform or stand for use. In embodiments, a hot water heater could be leaned onto a dolly, wheeled into place, and then stood upright from the dolly onto a platform. This solves the problem of deadlifting a water heater onto a platform or stand during installation.

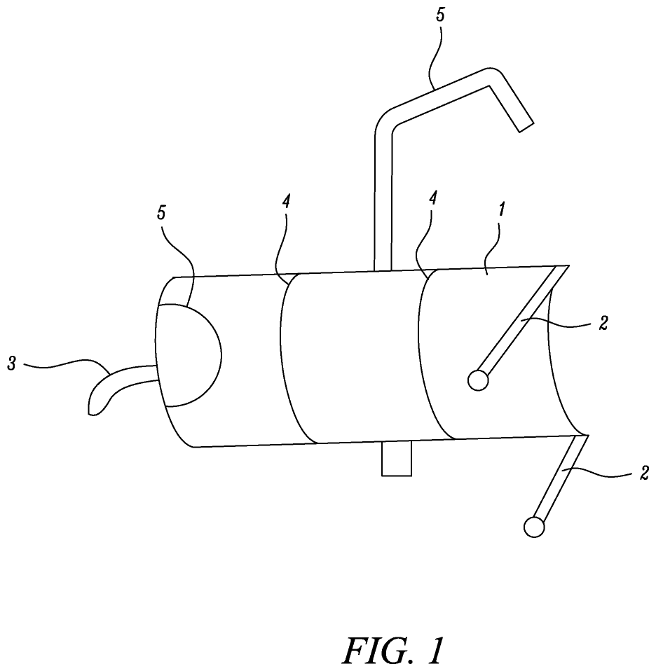

FIG. 1 shows one embodiment of a water heater dolly or truck of the present disclosure. In this embodiment, the dolly includes a seat 1, legs 2, handle 3, padded bars 4, and straps 5. Legs 2 may be foldable or collapsible for easy storage. In embodiments, the dolly could hang from the top of the water heater and when it is tilted back the wheels would touch and raise the bottom of the water heater. In one example, the bottom of the water heater could be raised approximately 22 inches while the stand would be at approximately 18 inches. That is, the water heater can be raised higher than the stand or platform. This makes it easy to lift and place a water heater onto a stand or platform for installation.

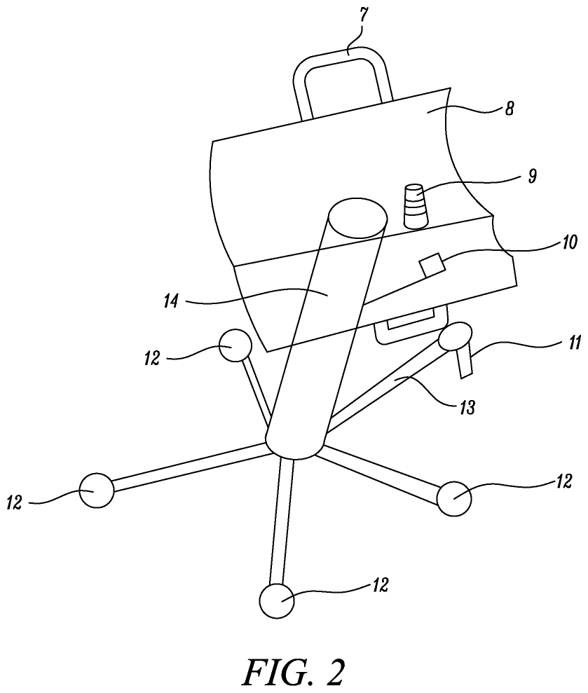

FIG. 2 shows another embodiment of a water heater dolly of the present disclosure. The dolly of FIG. 2 shows handle 7, seat 8, spring tension 9, adjustment lever 10, footbrake 11, wheels 12, extension bars for wheels 13, and leg 14.

The structure of the embodiment of FIG. 2 can be analogized to half of an office chair with modifications. It is also more sturdy.

The dolly of the disclosure may be made of metal, composites, plastics, rubber, or any other material commonly used in the art to make a dolly or hand truck.

The present disclosure provides a product that makes it easy to place a heater on a platform without struggling. It makes hot water heater installation safe and easy.

While this disclosure includes specific examples, it will be apparent after an understanding of the disclosure of this application has been attained that various changes in form and details may be made in these examples without departing from the spirit and scope of the claims and their equivalents.

What is claimed is:

1. A dolly for a water heater comprising:
a seat of a generally rectangular shape;
one or more legs disposed at one end of the seat;
a handle disposed opposite the legs; and
one or more straps attached to the seat.

2. The dolly of claim 1, wherein there are two legs.

3. The dolly of claim 1, wherein the legs are collapsible.

4. A dolly for a water heater comprising:
a seat;
one or more legs disposed at one end of the seat;
four wheels attached to the seat and disposed equidistant from each other;
a spring attached to the seat and disposed opposite to the leg;
a handle attached to the seat.

5. The dolly of claim 4, wherein there is one leg.

6. The dolly of claim 4, further comprising a brake.

7. The dolly of claim 4, wherein the brake is a foot brake.
